(19) United States
(12) Patent Application Publication
(10) Pub. No.: US 2009/0242655 A1
(43) Pub. Date: Oct. 1, 2009

(54) RAILROAD TIE THAT OBVIATES THE NEED FOR A TIE PLATE

(75) Inventors: Thomas Nosker, Stockton, NJ (US); Jennifer K. Lynch, Franklin Park, NJ (US)

Correspondence Address: FOX ROTHSCHILD LLP;PRINCETON PIKE CORPORATE CENTER, 2000 Market Street, Tenth Floor, Philadelphia, PA, 19103, US

(73) Assignee: RUTGERS, THE STATE UNIVERSITY OF NEW JERSEY, New Brunswick, NJ (US)

(21) Appl. No.: 12/295,574

(22) PCT Filed: Mar. 30, 2007
(86) PCT No.: PCT/US07/65627

§ 371 Date: Sep. 30, 2008

Related U.S. Application Data
(60) Provisional application No. 60/787,169, filed on Mar. 30, 2006.

(51) Int. Cl. E01B 3/44; B29C 47/88

(52) U.S. Cl. 238/84; 264/299

(57) ABSTRACT

A plastic or polymer composite railroad tie, which includes at least one rail seat bordered on at least one side by a raised portion of the tie.

### CROSS-REFERENCE TO RELATED APPLICATIONS

This application claims priority to U.S. Provisional Application Ser. No. 60/787,169, which was filed on Mar. 30, 2006, the disclosure of which is incorporated herein by reference.

### BACKGROUND OF THE INVENTION

Several systems have been contemplated in the prior art for fastening tie plates or the like to railroad ties. However, most have proved to be complicated, expensive to construct and maintain, and labor intensive or perhaps even dangerous to utilize.

The prior art has yet to contemplate an efficient, cost effective, yet safe and relatively uncomplicated system for pre-plating railroad ties or the like. Perhaps this is why manual installation is still considered, by far, the most cost effective means of accomplishing this task. However, with increasing labor and health insurance costs, as well as the inherent limitations of speed and supervision involved with a work crew, eliminating the tie plating step from railroad track installation would decrease costs associated with installing the track and would improve installation efficiency.

### SUMMARY OF THE INVENTION

The present invention is directed to a plastic or polymer composite railroad tie, which includes at least one rail seat bordered on at least one side by a raised portion of the tie. The rail seat and raised portion are capable of supporting a rail such that a separately installed tie plate is not necessary.

In one embodiment, the rail seat is located from 0 to 0.25 inches below the surface of the tie. In another embodiment, the rail seat is located from 0 to 0.25 inches above the surface of the tie. In one embodiment, the rail set is bordered on two opposite sides by raised portions of the tie.

In yet another embodiment, the railroad tie includes at least one pre-drilled hole. One embodiment includes a second rail seat bordered on at least one side by a raised portion of the tie.

In one embodiment, the railroad tie includes a composite material formed from a mixture of (a) high density polyolefin and one or both of: (b) a thermoplastic-coated fiber material; or (c) polystyrene, poly(methyl methacrylate), or a combination thereof. In yet another embodiment, the railroad tie includes a mixture of high density polyolefin and poly(methyl methacrylate).

In one embodiment, the railroad tie has a compressive modulus of at least about 250,000 psi (American Society for Testing and Materials (ASTM) D 6108) along the tie axis. In another embodiment, attached rails will not separate by more than 0.3175 cm under a lateral load of at least 24,000 lbs., a vertical static load of at least 39,000 lbs., or a dynamic vertical load of at least 140,000 lbs (The American Railway Engineering and Maintenance of Way Association (AREMA) specification from AREMA Committee 30: Ties, Sub-Committee 6: Engineered Composite Ties).

In yet another embodiment, the railroad tie includes a polymer component having distributed therein 10 to 80% by weight of a thermoplastic-coated fiber component based on the weight of the finished railroad tie wherein the thermoplastic-coated fiber has a minimum length of about 0.1 mm and wherein the polymer component contains between about 80 and about 100% by weight of HDPE based on the weight of the polymer component.

In another embodiment, the railroad tie includes a plastic composite material, which includes 20-50 wt % of a polystyrene component forming a first phase and 50-80 wt % of a polyolefin component forming a second phase, wherein the polystyrene component contains at least 90 wt % polystyrene and the polyolefin component contains at least 75 wt % high density polyethylene, and wherein the first phase and the second phase each form three dimensional networks that are integrated with one another within the composite material.

In one embodiment, the railroad tie is produced by extruding a plastic melt blend containing a polystyrene component forming a first phase and a polyolefin component forming a second phase, wherein within the plastic melt blend, the ratio of the viscosity of the polystyrene component to the viscosity of the polyolefin component is approximately equal to the ratio of the volume of the polystyrene component to the volume of the polyolefin component, and wherein the first phase and the second phase each form three dimensional networks that are integrated with one another within the composite material.

In another embodiment, the railroad tie includes an immiscible polymer blend, which includes polyethylene (PE) and acrylonitrile-butadiene-styrene (ABS) or polycarbonate (PC) or a mixture of ABS and PC, wherein the PE has a melt flow at 190° C./2.16 Kg of less than about 1 (ASTM D 1238), and the PC, ABS or mixture of PC and ABS has a melt flow at 190° C./2.16 Kg greater than about 1 (ASTM D 1238).

In yet another embodiment, the railroad tie is produced by making a mixed melt of a polystyrene having a storage modulus of at least about 10⁶ Pascals and a polyolefin component incorporating one or more polyolefins, the polystyrene and the polyolefin component being in intimate admixture with one another; forming the mixed melt so that the melt flows during the forming step; and cooling the formed mixed melt to solidify the same and thereby form the railroad tie.

### BRIEF DESCRIPTION OF THE DRAWINGS

FIG. 1 depicts a railroad tie of the present invention.

### DETAILED DESCRIPTION OF THE INVENTION

A plastic or polymer composite railroad tie, which includes at least one rail seat bordered on at least one side by a raised portion of the tie is presented.

The phrase “rail seat” as used herein refers to a portion of the railroad tie capable of supporting a rail. Preferably, the rail seat is located from about 0.25 inches below to about 0.25 inches above the surface of the tie. Preferably, the rail seat is bordered on two opposite sides by raised portions of the tie. In one embodiment, the railroad tie includes a second rail seat bordered on at least one side by a raised portion of the tie. The raised portions of the tie can be any suitable shape. Preferred shapes include triangular and rectangular raised portions.

The position of the rail with respect to the tie can be stabilized by the raised portions of the tie in combination with spikes installed into the raised portions of the tie. The exact position of the spikes can be determined by one of skill in the art based upon the tie material and the spike dimensions. Holes must be pre-drilled prior to spike installation. Pre-drilling could be done on-site by railroad workers or by the tie manufacturer based upon spike dimensions to be used.

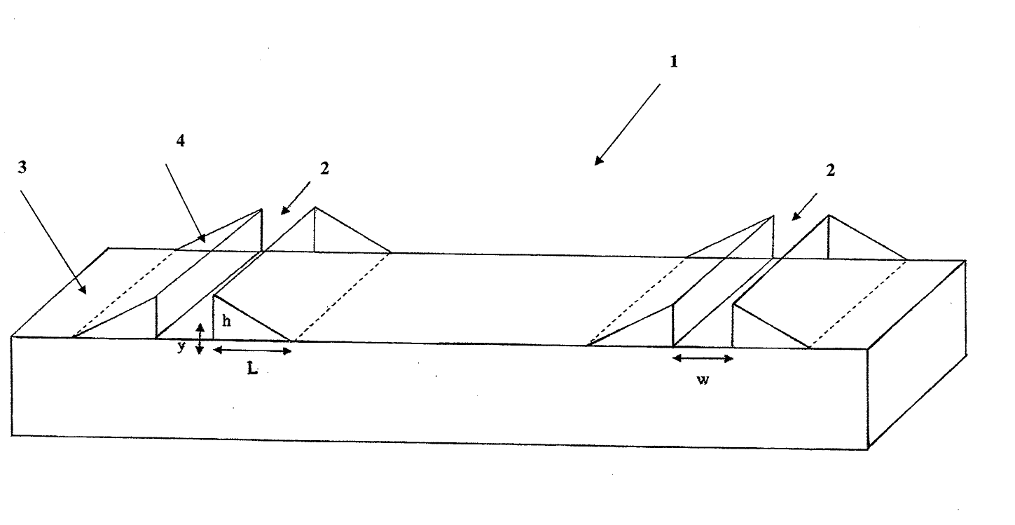

An exemplary railroad tie assembly is shown in FIG. 1. Railroad tie assembly 1 includes two rail seats 2 located along the top portion of the railroad tie 3. The location of the rail seat 2 relative to the surface of the tie 3 is indicated by “y.” The width of the rail seat is indicated by “w.” Preferably, “w” is equal to the width of the rail to be supported by the rail seat plus an amount less than ⅛ inch. In this embodiment, each rail seat 2 is bordered on two sides by raised portions 4 of the railroad tie 3. The height of the raised portion 4 is indicated by “h.” Preferably, “h” is from about 1/16 inch to about ½ inch. The length of the raised portion 4 is indicated by “L.” Preferably, “L” is greater than or equal to w/2.

It is important that the plastic or polymer composite materials used in fabricating the railroad tie of the present invention exhibit some very specific properties. For example, the material must be non-water or fuel absorbent, resistant to degradation and wear, resistant to the typical range of temperatures through which train tracks are exposed and non-conductive. In addition, the railroad ties must meet certain mechanical criteria. For example, the plastic or polymer composite railroad tie will have a compressive modulus of at least about 170,000 psi (ASTM D 6108) along the tie's axis. By the term “tie's axis” it is meant the longest axis of the railroad tie. More preferably, the plastic or polymer composite material will have a compressive modulus along the tie's axis of at least 200,000 psi (ASTM D 6108) and even more preferably 225,000 psi (ASTM D 6108). Most preferably, the plastic or polymer composite material will have a compressive modulus of at least about 250,000 psi (ASTM D 6108).

In addition, it is important that rails attached to the railroad ties of the present invention thereto not separate by more than about 0.3175 cm (0.125 in) when placed under a lateral load of a least about 24,000 lbs (AREMA specification from AREMA Committee 30: Ties, Sub-Committee 6: Engineered Composite Ties). Lateral load refers to the outward pressure exerted by the train's wheels on the rails. The plastic or polymer composite material should also bear a vertical static load of at least about 39,000 lbs. This measures a tie's ability to stand up to having a train parked on top of it without permanent deformation, or having the rail driven into the tie. A vertical dynamic load of at least 140,000 lbs. is also required. This measures the ability of a tie to handle train traffic.

Exemplary materials useful for fabricating the railroad ties of the present invention include the co-continuous polymer blend technology disclosed by U.S. Pat. Nos. 5,298,214 and 6,191,228 for blends of a high-density polyolefin and polystyrene, by U.S. Pat. Nos. 5,789,477 and 5,916,932 for blends of a high-density polyolefin and thermoplastic-coated fiber materials, by U.S. Publication No. 2005/0192403 for blends of polyethylene and acrylonitrile-butadiene-styrene and/or polycarbonate, and by International Publication No. 2006/125111 for blends of a high-density polyolefin and poly(methyl methacrylate). The disclosures of all six patents and applications are incorporated herein by reference.

As disclosed in International Publication No. 2006/125111, the polymer composite can be formed from a mixture of (a) high density polyolefin and one or both of: (b) a thermoplastic-coated fiber material; or (c) polystyrene, poly(methyl methacrylate), or a combination thereof. In one embodiment, the composite is a mixture of high density polyolefin and poly(methyl methacrylate).

Another suitable composite material, as disclosed in U.S. Pat. No. 6,191,228, contains from about 20 to about 50 wt % of a polystyrene component containing at least about 90 wt % polystyrene and from about 50 to about 80 wt % of a high-density polyolefin component containing at least about 75 wt % high-density polyethylene (HDPE). Composite materials containing about 25 to about 40 wt % of a polystyrene component are preferred, and composite materials containing about 30 to about 40 wt % of a polystyrene component are even more preferred. Polyolefin components containing at least about 80 wt % HDPE are preferred, and an HDPE content of at least about 90 wt % is even more preferred.

The blend technology disclosed in U.S. Pat. No. 6,191,228 can also be employed in the present invention to formulate composite materials for railroad ties comprising a poly(methyl methacrylate) component in place of or in addition to the polystyrene component. Composite materials may be employed containing a poly(methyl methacrylate) (PMMA) component containing at least 90 wt % PMMA with the balance of the composite material being a high-density polyolefin component containing at least 75 wt % high-density polyethylene (HDPE). Polyolefin components containing at least about 80 wt % HDPE are preferred, and an HDPE content of at least about 90 wt % is even more preferred. The minimum amount of the PMMA component in the blend is that quantity effective to produce a perceptible increase in melt viscosity (ASTM D 3835). Composite materials containing from about 0.1 to about 65 wt % of poly(methyl methacrylate) (PMMA) are preferred. Composite materials containing from about 10 to about 40 wt % of PMMA are more preferred, and composite materials containing from about 20 to about 35 wt % of PMMA are most preferred.

According to the process disclosed by U.S. Pat. No. 5,916,932 this composite may be further blended with thermoplastic-coated fibers having a minimum length of 0.1 mm so that the finished product contains from about 10 to about 80 wt % of the thermoplastic-coated fibers. U.S. Pat. No. 5,916,932 discloses composite materials containing from about 20 to about 90 wt % of a polymer component that is at least 80 wt % HDPE and from about 10 to about 80 wt % of thermoplastic-coated fibers.

The railroad tie of the present invention can also include a polymer component, disclosed in U.S. Pat. No. 5,789,477, having distributed therein 10 to 80% by weight of a thermoplastic-coated fiber component based on the weight of the finished railroad tie wherein said thermoplastic-coated fiber has a minimum length of about 0.1 mm and wherein said polymer component contains between about 80 and about 100% by weight of HDPE based on the weight of said polymer component.

The blend technology disclosed in U.S. Publication No. 20050192403 can also be used to formulate an immiscible polymer blend for railroad ties according to the present invention, wherein the blend includes polyethylene (PE) and acrylonitrile-butadiene-styrene (ABS) or polycarbonate (PC) or a mixture of ABS and PC, wherein said PE has a melt flow at 190° C./2.16 Kg of less than about 1 (ASTM D 1238), and said PC, ABS or mixture of PC and ABS has a melt flow at 190° C./2.16 Kg greater than about 1 (ASTM D 1238).

Railroad ties according to the present invention can also include polymer blends prepared by making a mixed melt consisting essentially of a polystyrene having a storage modulus of at least about 10⁶ Pascals and a polyolefin component incorporating one or more polyolefins, said polystyrene and said polyolefin component being in intimate admixture with one another; forming said mixed melt so that said melt flows during said forming step; and cooling said formed mixed melt to solidify the same and thereby form a solid product, as disclosed in U.S. Pat. No. 5,298,214.

Additional blends useful in the present invention include those disclosed in U.S. Pat. Nos. 4,663,388; 5,030,662; 5,212,223; 5,615,158; and 6,828,372. The contents of all five patents are incorporated herein by reference.

Exemplary techniques for preparing the railroad ties of the present invention include molding and extruding the plastic or polymer composite materials to obtain the desired shape. Other fabrication techniques include injection molding and intrusion. Intrusion combines the concepts of extrusion and injection molding, such that, the material is extruded and then fills a mold. Once the mold is filled, the extruded material can be re-directed to other molds, as desired. The molds could be fitted with inserts to obtain the raised portions for this invention.

For example, the molding processes disclosed in U.S. Pat. Nos. 5,298,214, 5,789,477, 5,916,932 and 6,191,228 may be employed to form the railroad ties of the present invention. However, because the railroad ties are formed having an irregular cross section in comparison to the beams having rectangular cross-sections that were previously molded, the composite blends are preferably extruded into molds from the extruder under force, for example from about 900 to about 1200 psi, to solidly pack the molds and prevent void formation. Likewise, it may be necessary to apply force along the horizontal tie axis, for example using a hydraulic cylinder extending the length of the horizontal axis, to remove cooled railroad ties from their molds.

Suitable fasteners for the railroad ties of the present invention are essentially conventional and include, without limitation, nails, screws, spikes, bolts, and the like.

The foregoing description of the preferred embodiment should be taken as illustrating, rather than as limiting, the present invention as defined by the claims. As would be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

What is claimed is:

1. A plastic or polymer composite railroad tie comprising at least one rail seat bordered on at least one side by a raised portion of said tie.

2. The railroad tie of claim 1, wherein said rail seat is from 0 to 0.25 inches below the surface of the tie.

3. The railroad tie of claim 1, wherein said rail seat is from 0 to 0.25 inches above the surface of the tie.

4. The railroad tie of claim 1, further comprising at least one pre-drilled hole.

5. The railroad tie of claim 1, further comprising a second rail seat bordered on at least one side by a raised portion of said tie.

6. The railroad tie of claim 1, wherein said rail seat is bordered on two opposite sides by raised portions of said tie.

7. The railroad tie of claim 1, wherein said composite is formed from a mixture of (a) high density polyolefin and one or both of: (b) a thermoplastic-coated fiber material; or (c) polystyrene, poly(methyl methacrylate), or a combination thereof.

8. The railroad tie of claim 7 comprising a mixture of high density polyolefin and poly(methyl methacrylate).

9. The railroad tie of claim 1 having a compressive modulus of at least about 250,000 psi (ASTM D 6108) along the tie axis.

10. The railroad tie of claim 1 wherein attached rails will not separate by more than 0.3175 cm under a lateral load of at least 24,000 lbs., a vertical static load of at least 39,000 lbs., or a dynamic vertical load of at least 140,000 lbs.

11. The railroad tie of claim 1 comprising a polymer component and distributed therein 10 to 80% by weight of a thermoplastic-coated fiber component based on the weight of the finished railroad tie wherein said thermoplastic-coated fiber has a minimum length of about 0.1 mm and wherein said polymer component contains between about 80 and about 100% by weight of HDPE based on the weight of said polymer component.

12. The railroad tie of claim 1, comprising a plastic composite material comprising 20-50 wt % of a polystyrene component forming a first phase and 50-80 wt % of a polyolefin component forming a second phase, wherein said polystyrene component contains at least 90 wt % polystyrene and said polyolefin component contains at least 75 wt % high density polyethylene, and wherein said first phase and said second phase each form three dimensional networks that are integrated with one another within said composite material.

13. The railroad tie of claim 1 produced by a method comprising: extruding a plastic melt blend containing a polystyrene component forming a first phase and a polyolefin component forming a second phase, wherein within said plastic melt blend, the ratio of the viscosity of the polystyrene component to the viscosity of the polyolefin component is approximately equal to the ratio of the volume of the polystyrene component to the volume of the polyolefin component, and wherein said first phase and said second phase each form three dimensional networks that are integrated with one another within said composite material.

14. The railroad tie of claim 1 comprising an immiscible polymer blend comprising polyethylene (PE) and acrylonitrile-butadiene-styrene (ABS) or polycarbonate (PC) or a mixture of ABS and PC, wherein said PE has a melt flow at 190° C./2.16 Kg of less than about 1 (ASTM D 1238), and said PC, ABS or mixture of PC and ABS has a melt flow at 190° C./2.16 Kg greater than about 1 (ASTM D 1238).

15. The railroad tie of claim 1 produced by a method comprising:
(a) making a mixed melt consisting essentially of a polystyrene having a storage modulus of at least about 10⁶ Pascals and a polyolefin component incorporating one or more polyolefins, said polystyrene and said polyolefin component being in intimate admixture with one another;
(b) forming said mixed melt so that said melt flows during said forming step; and
(c) cooling said formed mixed melt to solidify the same and thereby form said railroad tie.
